(19) United States
(12) Patent Application Publication
(10) Pub. No.: US 2026/0176450 A1
(43) Pub. Date: Jun. 25, 2026

(54) MCT OIL-COATED TITANIUM DIOXIDE PIGMENT FOR USE IN PLASTICS

(71) Applicant: Tronox LLC, Oklahoma City, OK (US)

(72) Inventors: Quan Su, Edmond, OK (US); Venkata Rama Rao Goparaju, Edmond, OK (US); Keven Stone, Meeker, OK (US); Charles Stewart Christ, JR., Edmond, OK (US)

(21) Appl. No.: 18/990,755

(22) Filed: Dec. 20, 2024

(51) Int. Cl. C08K 9/04; C09C 1/36

(52) U.S. Cl. CPC C08K 9/04; C09C 1/3661; C09C 1/3669; C09C 1/3692

(57) ABSTRACT

A process for producing a treated, titanium dioxide pigment for use in a polymer composition is provided. The process comprises providing a plurality of titanium dioxide pigment particles, each of the particles having a surface, and depositing an organic treating agent on the surfaces of the pigment particles in an amount in the range of from about 0.2% to about 2% by weight, based on the weight of the pigment particles. The organic treating agent includes at least one medium-chain triglyceride. A treated, titanium dioxide pigment for use in a polymer composition, and a polymer composition, are also provided.

### BACKGROUND

Titanium dioxide (TiO₂) is an effective pigment and white opacifying agent that is used in a variety of applications. For example, due to its high refractive index, strong opacifying ability and other properties, titanium dioxide is widely used as a pigment in coatings (for example, paint), paper, and plastics.

Purified titanium dioxide (TiO₂) is produced from raw ore (for example, ilmenite and rutile) by either the sulfate process or the chloride process. Each process can produce the pigment in its rutile crystalline form. The sulfate process can also produce the pigment in anatase crystalline form, which can be softer and particularly useful in certain applications. The produced titanium dioxide pigment is generally in powder form.

Whether produced by the sulfate process or the chloride process, the produced titanium dioxide pigment is generally further processed to form a finished pigment. For example, in the finishing process, the surfaces of the pigment particles are typically coated with one or more inorganic materials to modify or enhance the properties and characteristics of the pigment for use in the final application. Examples of inorganic materials coated onto the surfaces of the pigment particles include silica, zirconia, and alumina. For example, such materials can function to improve the opacity, light stability and/or durability of the pigment in the final product. The inorganic materials are normally coated on to the surfaces of the titanium dioxide particles by forming an aqueous slurry of the particles and depositing the inorganic materials on the surfaces of the particles in the slurry.

Following treatment of the titanium dioxide pigment with one or more inorganic materials in the slurry stage, the treated titanium dioxide pigment is filtered, washed and dried. The dry treated pigment is then milled in a fluidized energy mill such as a steam micronizer to break down agglomerates and reduce the particle size of the pigment.

Titanium dioxide pigments are widely used in plastics, including engineering plastics. A primary property that a titanium dioxide pigment imparts to a plastic product is opacity (hiding power). The opacity of a titanium dioxide pigment is based on the ability of the pigment to scatter light in the polymer composition to which it is added. The ability of the pigment to scatter light in a polymer composition depends on various factors, including the particle size distribution of the pigment and the difference in refractive index of the pigment particles and their surroundings.

The effectiveness of a titanium dioxide pigment in plastic products also depends on how evenly the pigment can be dispersed in the respective masterbatch and/or other polymer composition (collectively the “polymer composition”) to which it is added. To facilitate even distribution of a titanium dioxide pigment into a polymer composition, the pigment is formed into a finely divided powder, typically by milling or micronizing the pigment during the pigment finishing process. Unfortunately, titanium dioxide pigment powders tend to exhibit poor flow characteristics, which can make the amount of time and energy needed to sufficiently disperse the particles into a polymer composition excessively high.

In order to improve the flow characteristics and dispersion properties of the pigment in the polymer composition to which the pigment is added, titanium dioxide pigments are normally also treated with one or more organic compounds. The organic compounds can also facilitate griding of the pigment in the milling process. Examples of organic compounds that have been used include trimethylolpropane (TMP), phosphonic and phosphinic acids and derivatives thereof, silanes, siloxanes, and amines. The specific organic compound(s) used depends on the final application.

A problem is that many of the organic compounds that have been used heretofore are potentially toxic to humans, toxic to the environment, and/or unsustainable. For example, trimethylolpropane has been classified as a Category 2 human reproductive toxicant. Many of the organic compounds are synthesized from unsustainable precursors from the petroleum industry. The toxicity and/or unsustainability of organic compounds coated onto titanium dioxide pigments can particularly be a problem when the pigments are used in plastic applications, for example, water pipes, toys, food packaging, pharmaceutical packaging, and medical devices.

An example of a non-toxic organic compound that has been coated onto titanium dioxide pigments to improve the flow characteristics of the pigment is vegetable oil. Although vegetable oil is non-toxic, it can produce a strong odor and impart a significant yellow color to the product.

As a result, there is a need for non-toxic, environmentally friendly, and sustainable organic treating agents that effectively serve as grinding aids in the titanium dioxide pigment milling process, improve flow characteristics and dispersion properties of the pigment in polymer compositions and do not produce a strong odor or impart a significant yellow color to the product.

### SUMMARY

A process for producing a treated, titanium dioxide pigment for use in a polymer composition is provided. The process comprises providing a plurality of titanium dioxide pigment particles, each of the particles having a surface; and depositing an organic treating agent on the surfaces of the pigment particles in an amount in the range of from about 0.2% to about 2% by weight, based on the weight of the pigment particles, wherein the organic treating agent includes at least one medium-chain triglyceride.

A treated, titanium dioxide pigment for use in a polymer composition is also provided. The pigment comprises a plurality of titanium dioxide pigment particles, each of the particles having a surface; an inorganic treating agent deposited on the surfaces of the pigment particles; and an organic treating agent deposited on the surfaces of the pigment particles on top of the inorganic treating agent in an amount in the range of from about 0.2% to about 2% by weight, based on the weight of the pigment particles, wherein the organic treating agent includes at least one medium-chain triglyceride.

A polymer composition is also provided. The polymer composition comprises at least one polymer; and a treated, titanium dioxide pigment. The treated, titanium dioxide pigment includes: a plurality of titanium dioxide particles, each of the particles having a surface; and in the range of from about 0.2% to about 2% by weight, based on the weight of the titanium dioxide particles, of an organic treating agent deposited on the surfaces of the titanium dioxide particles, wherein the organic treating agent includes at least one medium-chain triglyceride.

### DETAILED DESCRIPTION

The present disclosure may be understood more readily by reference to this detailed description as well as to the examples included herein. Numerous specific details are set forth to provide a thorough understanding of the various aspects of this disclosure. However, this detailed description is not to be considered as limiting the scope of the claims. The subject matter disclosed herein is capable of considerable modifications, alterations, combinations, and equivalents in form and function, as will be evident to those skilled in the art with the benefit of this disclosure.

Whenever a range is disclosed herein, the range includes, independently and separately, every member of the range extending between any two numbers enumerated within the range. Furthermore, the lowest and highest numbers of any range shall be understood to be included within the disclosed range.

As used herein and in the appended claims, a component that “comprises” or “includes” one or more specified compounds means that the component includes the specified compound(s) alone or includes the specified compound(s) together with one or more additional compounds. A component that “consists of” one or more specified compounds means that the component includes only the specified compound(s). A component that “consists essentially of” one or more specified compounds means that the component consists of the specified compound(s) alone or consists of the specified compound(s) together with one or more additional compounds that do not materially affect the basic properties of the component.

As used herein and in the appended claims, unless stated otherwise, an expressed percent of a component is to be considered the percent by weight of the component based on a dry weight basis.

In one aspect, a process for producing a treated, titanium dioxide pigment for use in a polymer composition is disclosed herein. In another aspect, a treated titanium dioxide pigment for use in a polymer composition is disclosed herein. In yet another aspect, a polymer composition is disclosed herein.

### The Process for Producing a Treated, Titanium Dioxide Pigment

The process for producing a treated, titanium dioxide pigment for use in a polymer composition disclosed herein comprises providing a plurality of titanium dioxide particles, each of the particles having a surface; and depositing an organic treating agent on the surfaces of the pigment particles in an amount in the range of from about 0.2% to about 2% by weight, based on the weight of the pigment particles, wherein the organic treating agent includes at least one medium-chain triglyceride. Depositing the organic treating agent on the surfaces of the pigment particles forms a coating of the organic treating agent on the surfaces of the pigment particles. For example, the organic treating agent can consist essentially of at least one medium-chain triglyceride. For example, the organic treating agent can consist of at least one medium-chain triglyceride.

As used herein and in the appended claims, a titanium dioxide pigment means a particulate titanium dioxide, that is a titanium dioxide pigment in the form of a plurality of titanium dioxide pigment particles. For example, the titanium dioxide can be in dry powder or dry granule form. A polymer composition means a base polymer or polymer composition as well as a masterbatch or other additive composition for addition to a polymer or polymer composition.

As used herein and in the appended claims, “deposited on,” formed on,” and “precipitated on” the surfaces of the titanium dioxide pigment particles (or another component such as another coating) means deposited, formed or precipitated (as the case may be) directly or indirectly on the surfaces of the titanium dioxide pigment particles (or other component), unless stated otherwise. For example, unless stated otherwise, a treating agent deposited on the surfaces of the titanium dioxide particles means the treating agent is formed directly on the titanium dioxide particles or on one more organic and/or inorganic coatings that are directly or indirectly formed on the titanium dioxide particles.

For example, the titanium dioxide particles can be provided by producing the titanium dioxide pigment as part of the process disclosed herein. Alternatively, the titanium dioxide particles can be provided from a source of a titanium dioxide pigment that has already been produced. For example, one or more bulk containers (e.g., bags) of a pre-existing titanium dioxide pigment can be used a source of the titanium dioxide pigment.

The manner in which the titanium dioxide particles are produced, whether as part of the process disclosed herein or otherwise, is not critical. For example, the titanium dioxide particles can be titanium dioxide particles that have been produced by the sulfate process. For example, the titanium dioxide particles can be titanium dioxide particles that have been produced by the chloride process. The particles can have a rutile crystalline structure, an anatase crystalline structure, or a combination thereof. For example, the titanium dioxide particles can have a rutile crystalline structure. For example, the titanium dioxide particles can have an anatase crystalline structure.

In the sulfate process for producing titanium dioxide, a titanium slag ore, usually an ilmenite, is dissolved in sulfuric acid to form titanyl sulfate. The titanyl sulfate is then hydrolyzed to form hydrous titanium dioxide. The hydrated titanium dioxide is heated in a calciner to grow titanium dioxide crystals to pigmentary dimensions.

In the chloride process for producing titanium dioxide, a dry titanium dioxide ore is fed into a chlorinator together with coke and chlorine to produce a gaseous titanium halide (such as titanium tetrachloride). The produced titanium halide is purified and oxidized in a specially designed reactor at a high temperature to produce purified titanium dioxide particles having a desired particle size distribution. The titanium dioxide and gaseous reaction products are then cooled and the titanium dioxide particles are recovered.

The titanium dioxide particles can contain alumina as part of their lattice structure. For example, aluminum chloride can be added to the titanium halide in the oxidation reactor used in the chloride process to incorporate alumina into the crystal lattice of the titanium dioxide particles and thereby facilitate rutile formation and control particle size.

For example, the organic treating agent can be deposited on the surfaces of the pigment particles in an amount in the range of from about 0.3% to about 1.6% by weight, based on the weight of the pigment particles. For example, the organic treating agent can be deposited on the surfaces of the pigment particles in an amount in the range of from about 0.4% to about 1.2% by weight, based on the weight of the pigment particles. For example, the organic treating agent can be deposited on the surfaces of the pigment particles in an amount in the range of from about 0.4% to about 0.7% by weight, based on the weight of the pigment particles. As used herein and in the appended claims, unless stated otherwise, “based on the weight of the titanium dioxide particles” means based on the weight of the raw titanium dioxide particles in dry form.

As used herein and in the appended claims, a medium-chain triglyceride, also known as MCT oil, means a compound having three saturated fatty acids attached to a glycerol backbone, wherein each of the saturated fatty acids has an aliphatic tail having in the range of from 5 to 12 carbon atoms. The total number of carbon atoms in each of the saturated fatty acids, counting the carbon atom in the associated carboxyl (COO) group, is from 6 to 13.

For example, each of the saturated fatty acids of the medium-chain triglyceride can have an aliphatic tail having in the range of from 5 to 11 carbon atoms. For example, each of the saturated fatty acids of the medium-chain triglyceride can have an aliphatic tail having in the range of from 5 to 10 carbon atoms. For example, each of the saturated fatty acids of the medium-chain triglyceride can have an aliphatic tail having in the range of from 6 to 11 carbon atoms. For example, each of the saturated fatty acids of the medium-chain triglyceride can have an aliphatic tail having in the range of from 6 to 10 carbon atoms. For example, each of the saturated fatty acids of the medium-chain triglyceride can have an aliphatic tail having in the range of from 7 to 10 carbon atoms. For example, each of the saturated fatty acids of the medium-chain triglyceride can have an aliphatic tail having in the range of from 7 to 9 carbon atoms. For example, each of the saturated fatty acids of the medium-chain triglyceride can have an aliphatic tail having in the range of from 8 to 10 carbon atoms. For example, each of the saturated fatty acids of the medium-chain triglyceride can have an aliphatic tail having in the range of from 8 to 9 carbon atoms.

An example of a medium-chain triglyceride that can be used herein is shown by structure (1) below:

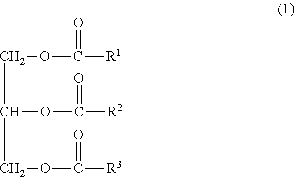

Structure (1) represents a medium-chain triglyceride having three statured fatty acids, wherein R¹, R² and R³ of the saturated fatty acids are each an aliphatic tail having in the range of from 5 to 12 carbon atoms. For example, when each of the aliphatic tails (R¹, R² and R³) have in the range of from 5 to 12 carbon atoms, the total number of carbon atoms in each of the saturated fatty acids, counting the carbon atom in the associated carboxyl (COO) group, is from 6 to 13. For example, R¹, R² and R³ can each be an aliphatic tail having in the range of from 5 to 11 carbon atoms. For example, R¹, R² and R³ can each be an aliphatic tail having in the range of from 5 to 10 carbon atoms. For example, R¹, R² and R³ can each be an aliphatic tail having in the range of from 6 to 11 carbon atoms. For example, R¹, R² and R³ can each be an aliphatic tail having in the range of from 6 to 10 carbon atoms. For example, R¹, R² and R³ can each be an aliphatic tail having in the range of from 7 to 10 carbon atoms. For example, R¹, R² and R³ can each be an aliphatic tail having in the range of from 7 to 9 carbon atoms. For example, R¹, R² and R³ can each be an aliphatic tail having in the range of from 8 to 10 carbon atoms. For example, R¹, R² and R³ can each be an aliphatic tail having in the range of from 8 to 9 carbon atoms. The number of carbon atoms in each of R¹, R² and R³ can be the same or can vary within the above range.

For example, the organic treating agent can include a single medium-chain triglyceride (that is, one compound). Alternatively, the organic treating agent can include two or more medium-chain triglycerides (that is, two or more different compounds), with each medium chain triglyceride having a different structure, for example, a different number of carbon atoms (within the range of from 5 to 12 carbon atoms) in the aliphatic tails of at least two of the fatty acids.

For example, a medium-chain triglyceride suitable for use herein can be found in grocery stores as a healthy edible oil. It can be extracted from coconut oil or palm kernel oil. A medium-chain triglyceride suitable for use herein can also be synthesized by: (1) a transesterification reaction of glycerol esters with three fatty acids, each having in the range of from 6 to 13 total carbon atoms; (2) a transesterification reaction of glycerol with three fatty acids esters, each having in the range of from 6 to 13 total carbon atoms; or (3) a condensation reaction of glycerol with three fatty acids, each having in the range of from 6 to 13 total carbon atoms. Such a condensation reaction is shown by reaction (1) below:

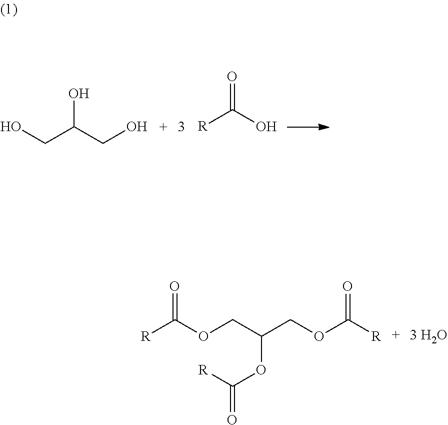

R represents an aliphatic tail having in the range of from 5 to 12 carbon atoms.

The organic treating agent can be deposited on the surfaces of the titanium dioxide pigment particles by any technique for surface treating pigments known in the art. For example, the organic treating agent can be deposited on the surfaces of the pigment particles in a fluid energy mill. The organic treating agent can be mixed with or sprayed on the pigment particles when the titanium dioxide pigment particles are in dry form. The organic treating agent can also be added to a slurry or paste containing the pigment particles and dried therewith. For example, in order to help prevent degradation of the medium-chain triglyceride(s) forming the organic treating agent, the pH of the slurry, paste, filter cake or other medium to which the organic treating agent is added or mixed is greater than 6. For example, the pH of the slurry, paste, filter cake or other medium to which the organic treating agent is added or mixed is in the range of from greater than 6 to 10. For example, the pH of the slurry, paste, filter cake or other medium to which the organic treating agent is added or mixed is in the range of from 7 to 9.

For example, in one embodiment, the process further comprises, prior to depositing the organic treating agent on the surfaces of the titanium dioxide pigment particles, forming a slurry of the pigment particles, and filtering the slurry to form a filter cake that includes the pigment particles. The organic treating agent is deposited on the surfaces of the pigment particles by mixing the organic treating agent with the filter cake.

For example, by the filtration step, the pigment particles are washed and recovered. The recovered pigment particles can then be dried as part of the pigment finishing process. The organic treating agent can be mixed with the filter cake before or after the filter cake is dried. For example, the organic treating agent is mixed with the filter cake before the filter cake is dried. For example, the organic treating agent is mixed with the filter cake after the filter cake is dried.

For example, the process can further comprise: after the organic treating agent is mixed with the filter cake to deposit the organic treating agent on the surfaces of the pigment particles and after the filter cake is dried, milling the treated pigment particles. For example, the pigment particles can be milled in a fluid energy mill. For example, the pigment particles can be milled by steam micronization techniques. For example, the organic treating agent serves as a grinding aid and facilitates the milling process.

For example, in one embodiment, the process further comprises depositing an inorganic treating agent on the surfaces of the pigment particles. Depositing the inorganic treating agent on the surfaces of the pigment particles forms a coating of the inorganic treating agent on the surfaces of the pigment particles. For example, the inorganic treating agent is deposited on the surfaces of the pigment particles prior to depositing the organic treating agent on the surfaces of the pigment particles. For example, the organic treating agent can be deposited on top of the coating of the inorganic treating agent to form a coating thereon.

For example, a first inorganic treating agent can be deposited on the surfaces of the pigment particles to form a coating of the first inorganic treating agent thereon, and a second inorganic treating agent can be deposited on the coating of the first inorganic treating agent to form a coating of the second organic treating agent thereon. A third inorganic treating agent can then be deposited on the coating of the second inorganic treating agent to form a coating of the third inorganic treating agent thereon, and so forth and so on.

For example, when more than one inorganic treating agent is deposited on the surfaces of the pigment particles to form more than one inorganic treating agent coating thereon, the organic treating agent is deposited on top of all the coatings of the inorganic treating agents. For example, if first and second inorganic treating agents are deposited, directly or indirectly, on the surfaces of the pigment particles, the organic treating agent is then deposited on top of the coating of the second inorganic treating agent. For example, depositing the organic treating agent on top of the coating(s) of the inorganic treating agents (and any other organic materials deposited on the surfaces of the titanium dioxide particles) can enhance the compatibility of the pigment with a polymeric resin system, for example, when the treated titanium dioxide pigment is added to a polyolefin.

For example, the inorganic treating agent(s) can be deposited on the surfaces of the titanium dioxide particles by forming an aqueous slurry of the titanium dioxide particles, and precipitating the inorganic treating agent(s) onto the surfaces of the titanium dioxide particles in the slurry to form one or more coating(s) of the inorganic treating agent thereon. Techniques for precipitating one or more inorganic or organic treating agents directly or indirectly on the surfaces of titanium dioxide particles such as titanium dioxide pigment particles in a slurry containing the titanium dioxide particles by successively adding each treating agent to the slurry and adjusting the pH of the slurry as necessary to cause the treating agents to precipitate on the surfaces of the titanium dioxide particles are known in the art. The inorganic and organic treating agent(s) are precipitated onto the titanium dioxide particles in situ in the aqueous slurry.

For example, the inorganic treating agent(s) is selected from the group consisting of metal oxide materials, metal hydroxide materials, and combinations thereof. For example, the inorganic treating agent(s) is selected from the group of oxides or hydroxides of silica, oxides or hydroxides of alumina, oxides or hydroxides of aluminum phosphate, oxides or hydroxides of zirconia, oxides or hydroxides of titania, and combinations thereof. For example, the inorganic treating agent(s) is selected from the group of oxides or hydroxides of silica, oxides or hydroxides of alumina, oxides or hydroxides of zirconia, and combinations thereof. If more than one inorganic treating agent is utilized, the inorganic treating agents can be the same or different. For examples, the same aluminum compound can be separately added to the slurry to deposit two or more layers or coatings of alumina on the surfaces of the pigment particles.

For example, in order to deposit a metal oxide inorganic treating agent on the surfaces of a plurality of titanium dioxide particles to form a coating thereon, the metal oxide inorganic treating agent can be incrementally added to the aqueous slurry as an aqueous metal oxide salt solution. The pH and temperature of the slurry can be adjusted and maintained at levels that cause precipitation of the specific metal oxide inorganic treating agent to occur. In order to control the pH of the slurry, strong inorganic acids such as hydrochloric acid, nitric acid, sulfuric acid and salts thereof can be used. For example, each separate inorganic treating agent precipitated onto the surfaces of the titanium dioxide particles in the slurry forms a separate coating directly or indirectly on the surfaces of the titanium dioxide particles.

The inorganic treating agent(s) can be used to impart one or more properties and/or characteristics to the titanium dioxide particles, or enhance the same, to make the particles more suitable for the end-use application, that is, for use in the base composition (for example, the polymer composition) to which the titanium dioxide is to be added and products produced therefrom (for example, plastic articles). For example, silica and/or alumina treating agents can be used to help improve the wetting and dispersing properties of a titanium dioxide pigment as well as the opacity, light stability and durability of the pigment.

For example, the inorganic treating agent(s) can be deposited on the surfaces of the titanium dioxide particles in an amount in the range of about 0.5% by weight to about 15% by weight, based on the total weight of the raw titanium dioxide particles and all inorganic and organic materials deposited thereon. For example, the inorganic treating agent(s) can be deposited on the surfaces of the titanium dioxide particles in an amount in the range of about 1% by weight to about 10% by weight, based on the weight of the raw titanium dioxide particles and all inorganic and organic materials deposited thereon.

For example, in one embodiment, the organic treating agent referenced above is a second organic treating agent, and the process further comprises: depositing a first organic treating agent on the surfaces of the pigment particles. Depositing the first organic treating agent on the surfaces of the pigment particles forms a coating of the first organic treating agent on the surfaces of the pigment particles.

For example, like the second organic treating agent, the first organic treating agent can be deposited on the surfaces of the pigment particles to form a coating of the first organic treating agent thereon by any technique for surface treating pigments known in the art. For example, the first organic treating agent can be deposited on the surfaces of the pigment particles in a fluid energy mill. The first organic treating agent can be mixed with or sprayed on the surfaces of the pigment particles when the pigment particles are in dry form. The first organic treating agent can also be added to a slurry containing the pigment particles and dried therewith.

By way of further example, like the second organic treating agent, the first organic treating agent can be mixed with a filter cake containing the pigment particles as described above (either before or after the filter cake is dried). The treated pigment particles (now containing the first organic treating agent, the second organic treating agent and, optionally, one or more inorganic treating agents) can then be milled as described above.

For example, the first organic treating agent can be deposited on the surfaces of the pigment particles prior to depositing the second organic treating agent on the surfaces of the pigment particles. For example, in one embodiment, after a filter cake that includes the pigment particles is formed as described above, the first organic treating agent is deposited on the surfaces of the pigment particles forming the filter cake to form a coating of the first organic treating agent thereon. Next, the second organic treating agent is deposited on the surfaces of the pigment particles forming the filter cake to form a coating of the second organic treating agent on top of the first organic treating agent coated on the pigment particles. For example, after the first organic treating agent is deposited on the surfaces of the pigment particles forming the filter cake, and prior to depositing the second organic treating agent on the surfaces of the pigment particles forming the filter cake, the filter cake can be dried. Once both of the first and second treating agents are deposited on the pigment particles forming the filter cake, the treated pigment particles (now containing the first organic treating agent, the second organic treating agent and, optionally, one or more inorganic treating agents) can then be milled as described above.

For example, the first organic treating agent can be selected from the group consisting of phosphinic acids, derivatives of phosphinic acids (e.g., salts or esters thereof), phosphonic acids, derivatives of phosphonic acids (e.g., salts or esters thereof), fatty acids, derivatives of fatty acids (e.g., salts or esters thereof), siloxanes, amines, hydroxyl amines, polyols, silanes, and combinations thereof.

Examples of phosphinic acids and derivatives of phosphinic acids that can be used as the first organic treating agent include bis(2,4,4-trimethylpentyl) phosphinic acid, bis(2-ethylhexyl phosphinic acid), oleyl phosphinic acid, n-octadecyl phosphinic acid, esters of phosphinic acids, salts of phosphinic acids, and combinations thereof. An example of an ester of a phosphinic acid that can be used is bis(2-ethylhexyl)phosphinic acid 2-ethylhexyl ester.

Examples of phosphonic acids and derivatives of phosphonic acids that can be used as the first organic treating agent include n-octylphosphonic acid, decylphosphonic acid, dodecylphosphonic acid, octylphosphonic acid, esters of phosphonic acids, salts of phosphonic acids, and combinations thereof. Examples of esters of phosphonic acids that can be used include esters of alkylphosphonic acids. An example of a salt of a phosphonic acid that can be used is monoethyl ester potassium salt.

Examples of fatty acids and derivatives of fatty acids that can be used as the first organic treating agent include stearic acid, palmitic acid, lauric acid, oleic acid, and esters and salts of stearic acid, palmitic lauric acid, and oleic acid.

Examples of siloxanes that can be used as the first organic treating agent include polydimethyl siloxane, copolymers of polydimethyl siloxane and polymethyl hydrogen siloxane, n-octyltriethoxy silane, silicone alkylpolyethers, silicone polyether carboxylates, and combinations thereof.

Examples of amines and hydroxyl amines that can be used as the first organic treating agent include triethanolamine, Triisopropanol amine, and tris (hydroxymehtyl)aminomethane.

Examples of polyols that can be used as the first organic treating agent include glycerol, xylitol, mannitol, and erythritol.

Examples of silanes that can be used as the first organic treating agent include octyltrichloro silane, octyltrimethoxy silane and octyltriethoxy silane.

For example, the first organic treating agent can be selected from the group consisting of alkyl phosphinic acids, phosphonic acids, siloxanes, and combinations thereof. For example, the first organic treating agent can be one or more alkyl phosphinic acids. For example, the first organic treating agent can be bis(2,4,4-trimethylpentyl) phosphinic acid.

For example, the first organic treating agent can be deposited on the surfaces of the pigment particles in an amount in the range of from about 0.05% to about 1.0% by weight, based on the weight of the pigment particles. For example, the organic treating agent can be deposited on the surfaces of the pigment particles in an amount in the range of from about 0.1% to about 0.8% by weight, based on the weight of the pigment particles. For example, the organic treating agent can be deposited on the surfaces of the pigment particles in an amount in the range of from about 0.2% to about 0.6% by weight, based on the weight of the pigment particles.

For example, in one embodiment, the process for producing a treated, titanium dioxide pigment for use in a polymer composition disclosed herein comprises the following steps:
(a) providing a plurality of titanium dioxide particles;
(b) after step (a), forming an aqueous slurry of the titanium dioxide particles;
(c) after step (b), reducing the particle size of the titanium dioxide particles in the aqueous slurry to a desired particle size (for example, a desired particle size distribution);
(d) after step (c), depositing at least one inorganic treating agent onto the surfaces of the titanium dioxide pigment particles in the aqueous slurry;
(e) after step (d), filtering the treated titanium dioxide particles to form a filter cake that includes the treated, titanium dioxide particles;
(f) after step (e), mixing the organic treating agent with the filter cake to deposit the organic treating agent on the titanium dioxide particles;
(g) after step (e), drying the filter cake; and
(h) after step (g), reducing the particle size of the treated, titanium dioxide particles forming the filter cake to a desired particle size (for example, a desired particle size distribution).

As discussed above, the titanium dioxide particles can be provided in step (a) by producing the titanium dioxide pigment as part of the process disclosed herein. Alternatively, the titanium dioxide particles can be provided in step (a) from a source of titanium dioxide that has already been produced.

A slurry of the titanium dioxide particles can be formed in step (b) by mixing the titanium dioxide particles into an aqueous medium. If necessary or desired, a dispersing agent such as a polyphosphate can be added to the aqueous slurry to facilitate distribution of the titanium dioxide particles therein. For example, the titanium dioxide particles can be added to the aqueous slurry in an amount in the range of from about 5% by weight to about 65% by weight, based on the total weight of the slurry. By way of further example, the titanium dioxide particles are added to the slurry in an amount in the range of from about 15% by weight to about 45% by weight, based on the total weight of the slurry. For example, the titanium dioxide particles are added to the aqueous slurry in an amount in the range of from about 25% by weight to about 40% by weight, based on the total weight of the slurry.

The particle size of the titanium dioxide particles can be reduced in the aqueous slurry to a desired particle size distribution in step (c) by wet milling the pigment particles in the aqueous slurry. For example, the pigment particles in the aqueous slurry can be wet milled to cause at least about 50% of the titanium dioxide particles in the slurry to have a particle size of less than 0.5 microns. Various wet milling techniques known in the art can be used to carry out the wet milling step, including cage milling, bead milling, jet milling and sand milling.

The inorganic treating agent(s) can be deposited onto the surfaces of the titanium dioxide particles in the aqueous slurry in accordance with step (d) by precipitating the inorganic treating agent(s) onto the surfaces of the titanium dioxide particles as discussed above. If more than one inorganic treating agent is used, the inorganic treating agents can be separately and successively precipitated onto the surfaces of the titanium dioxide particles as discussed above. As a result, one or more coatings of the inorganic treating agent(s) are formed on the surfaces of the titanium dioxide particles in the slurry.

The treated titanium dioxide particles can be filtered to form the filter cake that includes the surface treated, titanium dioxide particles in accordance with step (e) by methods known to those skilled in the art. For example, the treated titanium dioxide particles can be recovered by filtration to form a filter cake of the particles and washed using conventional vacuum-type and/or pressure-type filtration systems. The wet treatment deposition of the inorganic treating agent(s) onto the titanium dioxide particles (for example, onto the wet-milled titanium dioxide particles) helps enable the pigment to be recovered and washed using conventional vacuum-type and/or pressure-type filtration systems.

As stated above, the organic treating agent mixed with the filter cake in accordance with step (f) includes at least one medium-chain triglyceride. Mixing the organic treating agent with the filter cake deposits the organic treating agent on the titanium dioxide particles (for example, on top of the coating(s) of the inorganic treating agent(s)).

As stated above, the organic treating agent can be a second organic treating agent, and the process can further comprise depositing a first organic treating agent on the surfaces of the pigment particles. For example, step (f) can include mixing both the first organic treating agent and the second organic treating agent with the filter cake to deposit the first and second organic treating agents on the coating(s) of the inorganic treating agent(s), as described above. The first and second organic treating agent can be mixed with the filter cake in accordance with step (g) either separately or as a mixture. The order of addition of the first and second organic treating agents is not critical.

The filter cake can be dried in accordance with step (g) by vacuum drying, spin-flash drying, spray drying, or any other technique known to those skilled in the art to produce a dry titanium dioxide powder. In one embodiment, the filter cake is dried in accordance with step (g) by spray drying the particles. As stated above, the organic treating agent can be mixed with the filter cake before or after the filter cake is dried. If the organic treating agent is a second organic treating agent and a first organic treating agent is also deposited on the surfaces of the pigment particles, as discussed above, both the first and second organic treating agents can be mixed with the filter cake before or after the filter cake is dried. For example, in one embodiment, the first organic treating agent is mixed with the filter cake before the filter cake is dried, and the second treating agent is mixed with the filter cake after the filter cake is dried.

The particle size of the treated, titanium dioxide particles forming the dried filter cake can be reduced to the desired particle size (for example, the desired particle size distribution) in step (h) by, for example, dry milling the pigment particles. For example, a fluid energy mill can be used to dry mill the pigment particles. Alternatively, the dried pigment particles can be reduced to the desired particle size (for example, the desired particle size distribution) by steam micronization (for example, steam milling).

In one embodiment, the process described above further comprises: (i) after step (h), packaging the treated, titanium dioxide pigment. The treated, titanium dioxide pigment can be packaged by any packaging technique known in the art. For example, the dried and milled treated inorganic oxide pigment can be placed in bags and shipped therein.

In one embodiment, an inorganic treating agent is not deposited on the surfaces of the titanium dioxide particles, that is, step (d) is not included. In this embodiment, the first organic treating agent, and optionally the second organic treating agent, are deposited, directly or indirectly, on the surfaces of the pigment particles.

### The Treated, Titanium Dioxide Pigment

The treated, titanium dioxide pigment for use in a polymer composition provided herein comprises: a plurality of titanium dioxide particles, each of the particles having a surface; an inorganic treating agent deposited on the surfaces of the pigment particles; and an organic treating agent deposited on the surfaces of the titanium dioxide particles on top of the inorganic treating agent in an amount in the range of from about 0.2% to about 2% by weight, based on the weight of the pigment particles, wherein the organic treating agent includes at least one medium-chain triglyceride. By being deposited on the surfaces of the pigment particles, the inorganic treating agent forms a coating on the surfaces of the pigment particles. Similarly, by being deposited on the surfaces of the pigment particles on top of the inorganic treating agent, the organic treating agent forms a coating on the surfaces of the pigment particles on top of the coating of the inorganic treating agent.

The titanium dioxide particles in the treated, titanium dioxide pigment are the same as the titanium dioxide particles described above in connection with the process for producing a treated, titanium dioxide pigment for use in a polymer composition disclosed herein.

Similarly, the inorganic treating agent and the amounts thereof deposited on the surfaces of the pigment particles in the treated, titanium dioxide pigment are the same as the inorganic treating agent and amounts thereof described above in connection with the process for producing a treated, titanium dioxide pigment for use in a polymer composition disclosed herein.

Similarly, the organic treating agent (the at least one medium-chain triglyceride) and the amounts thereof deposited on the surfaces of the pigment particles in the treated, titanium dioxide pigment are the same as the organic treating agent (the at least one medium-chain triglyceride) and amounts thereof described above in connection with the process for producing a treated, titanium dioxide pigment for use in a polymer composition disclosed herein. For example, as stated above, the organic treating agent can consist of at least one medium-chain triglyceride. For example, as stated above, the organic treating agent can consist essentially of at least one medium-chain triglyceride.

For example, as described above in connection with the process disclosed herein, the treated, titanium dioxide pigment can include a first inorganic treating agent deposited on the surfaces of the pigment particles to form a coating of the first inorganic treating agent thereon, and a second inorganic treating agent deposited on the coating of the first inorganic treating agent to form a coating of the second organic treating agent thereon. A third inorganic treating agent can be deposited on the coating of the second inorganic treating agent to form a coating of the third inorganic treating agent thereon, and so forth and so on. When more than one inorganic treating agent is deposited on the surfaces of the pigment particles to form more than one inorganic treating agent coating thereon, the organic treating agent is deposited on top of all of the coatings of the inorganic treating agents.

For example, in one embodiment, the organic treating agent deposited on surfaces of the pigment particles in the treated, titanium dioxide pigment disclosed herein is a second organic treating agent, and the treated titanium dioxide pigment further comprises a first organic treating agent deposited on the surfaces of the pigment particles. For example, the second organic treating agent can be deposited on top of the first organic treating agent. The first organic treating agent and the amounts thereof deposited on the surfaces of the pigment particles (for example, on top of the inorganic treating agent) in the treated, titanium dioxide pigment disclosed herein are the same as the first organic treating agent and amounts thereof described above in connection with the process for producing a treated, titanium dioxide pigment for use in a polymer composition disclosed herein.

For example, the treated titanium dioxide pigment can be formed by the process disclosed herein.

### The Polymer Composition

The polymer composition disclosed herein comprises at least one polymer; and a treated, titanium dioxide pigment. The treated, titanium dioxide pigment is the treated, titanium dioxide pigment described above and disclosed herein.

Polymers suitable for use in the polymer composition include both thermoplastic and thermoset polymers. Examples of thermoplastic polymers include polyolefins such as polyethylene (PE) (for example, low density polyethylene (LDPE)), linear low density polyethylene (LLDPE)) and polypropylene (PP), acrylic resins such as poly(methyl methacrylate), polyester resins such as polyethylene terephthalate (PET), polyamide (PA) resins, styrenic resins such as polystyrene (PS), acrylonitrile-butadiene-styrene copolymer (ABS), polyvinyl chloride, (PVC), polycarbonate (PC) resins, and mixtures thereof. Examples of thermoset polymers include polyesters, polyacrylics, epoxy, and polyurethanes.

For example, the polymer(s) can be selected from the group consisting of polyolefins, acrylic resins, polyester resins, polyamide resins, styrenic resins, polyvinyl chloride, polycarbonate resins, and mixtures thereof. For example, the polymer(s) can be selected from the group consisting of polyethylene, polypropylene, poly(methyl methacrylate), polyethylene terephthalate, polyamide resins, acrylonitrile-butadiene-styrene copolymer, polyvinyl chloride, polycarbonate resins, and mixtures thereof.

The polymer composition can be formed by mixing the treated, titanium dioxide pigment with the polymer(s) by any method known in the art. For example, a slurry of the polymer(s) can be formed, and the treated, titanium dioxide pigment can be added to the slurry and mixed therein.

The amount of the treated, titanium dioxide pigment included in the polymer composition can vary depending on the type of polymer composition. For example, the treated, titanium dioxide pigment can be present in the polymer composition in an amount in the range of from about 1% to about 80% by weight, based on the total weight of the polymer composition. For example, the treated, titanium dioxide pigment can be present in the polymer composition in an amount in the range of from about 5% to about 75% by weight, based on the total weight of the polymer composition. For example, the treated, titanium dioxide pigment can be present in the polymer composition in an amount in the range of from about 30% to about 80% by weight, based on the total weight of the polymer composition. For example, the treated, titanium dioxide pigment can be present in the polymer composition in an amount in the range of from about 45% to about 65% by weight, based on the total weight of the polymer composition.

For example, the treated, titanium dioxide pigment can be mixed with one or more polymers together with a dispersant to prepare a 75% by weight titanium dioxide-containing polymeric master batch concentrate. The mixing process can be carried out, for example, via mastication of the mixture in the mixing bowl of a Plasticorder™ Model PL-2000 as sold by C.W. Brabender Instruments, Inc., at 100° C. and a mixing speed of 100 rpm.

As shown by the examples below, treatment of the titanium dioxide pigment with an organic treating agent including at least one medium-chain triglyceride, as disclosed herein, improves the flow properties, processability and dispersibility of the pigment in the polymer composition. The treated, titanium dioxide pigment can be dispersed in polymer compositions using less time and energy than untreated, titanium dioxide pigments.

The medium-chain triglyceride(s) used herein have comparable or better performance in plastics than trimethylolpropane (TMP) and other organic treating agents used heretofore. They are non-toxic to humans, non-toxic to the environment, environmentally friendly, biodegradable, and sustainable. They are stable and have a low volatility. Unlike vegetable oil, the medium-chin triglyceride(s) used herein do not produce a strong odor.

The medium-chain triglyceride(s) used herein also effectively serves as a grinding aid in the titanium dioxide pigment milling process.

In one embodiment, a process for producing a treated, titanium dioxide pigment for use in a polymer composition is provided. In this embodiment, the process comprises providing a plurality of titanium dioxide pigment particles, each of the particles having a surface; and depositing an organic treating agent on the surfaces of the pigment particles in an amount in the range of from about 0.3% to about 1.6% by weight, based on the weight of the pigment particles, wherein the organic treating agent includes at least one medium-chain triglyceride.

In another embodiment, a process for producing a treated, titanium dioxide pigment for use in a polymer composition is provided. In this embodiment, the process comprises providing a plurality of titanium dioxide pigment particles, each of the particles having a surface; and depositing an organic treating agent on the surfaces of the pigment particles in an amount in the range of from about 0.4% to about 1.2% by weight, based on the weight of the pigment particles, wherein the organic treating agent includes at least one medium-chain triglyceride.

In another embodiment, a process for producing a treated, titanium dioxide pigment for use in a polymer composition is provided. In this embodiment, the process comprises providing a plurality of titanium dioxide pigment particles, each of the particles having a surface; and depositing an organic treating agent on the surfaces of the pigment particles in an amount in the range of from about 0.2% to about 2% by weight, based on the weight of the pigment particles, wherein the organic treating agent includes at least one medium-chain triglyceride, wherein each of the aliphatic tails of the saturated fatty acids of the medium-chain triglyceride has in the range of from 5 to 11 carbon atoms.

In another embodiment, a process for producing a treated, titanium dioxide pigment for use in a polymer composition is provided. In this embodiment, the process comprises providing a plurality of titanium dioxide pigment particles, each of the particles having a surface; and depositing an organic treating agent on the surfaces of the pigment particles in an amount in the range of from about 0.2% to about 2% by weight, based on the weight of the pigment particles, wherein the organic treating agent includes at least one medium-chain triglyceride, wherein each of the aliphatic tails of the saturated fatty acids of the medium-chain triglyceride has in the range of from 7 to 9 carbon atoms.

In another embodiment, a process for producing a treated, titanium dioxide pigment for use in a polymer composition is provided. In this embodiment, the process comprises providing a plurality of titanium dioxide pigment particles, each of the particles having a surface; and depositing an organic treating agent on the surfaces of the pigment particles in an amount in the range of from about 0.2% to about 2% by weight, based on the weight of the pigment particles, wherein the organic treating agent includes two or more medium-chain triglycerides, with each medium chain triglyceride having a different structure.

In another embodiment, a process for producing a treated, titanium dioxide pigment for use in a polymer composition is provided. In this embodiment, the process comprises providing a plurality of titanium dioxide pigment particles, each of the particles having a surface; forming a slurry of the pigment particles, filtering the slurry to form a filter cake that includes the pigment particles, and depositing an organic treating agent on the surfaces of the pigment particles in an amount in the range of from about 0.2% to about 2% by weight, based on the weight of the pigment particles, by mixing the organic treating agent with the filter cake, wherein the organic treating agent includes at least one medium-chain triglyceride.

In another embodiment, a process for producing a treated, titanium dioxide pigment for use in a polymer composition is provided. In this embodiment, the process comprises providing a plurality of titanium dioxide pigment particles, each of the particles having a surface; depositing an inorganic treating agent on the surfaces of the pigment particles, and depositing an organic treating agent on the surfaces of the pigment particles in an amount in the range of from about 0.2% to about 2% by weight, based on the weight of the pigment particles, wherein the organic treating agent includes at least one medium-chain triglyceride.

In another embodiment, a process for producing a treated, titanium dioxide pigment for use in a polymer composition is provided. In this embodiment, the process comprises providing a plurality of titanium dioxide pigment particles, each of the particles having a surface; depositing a first organic treating agent on the surfaces of the pigment particles, and depositing a second organic treating agent on the surfaces of the pigment particles in an amount in the range of from about 0.2% to about 2% by weight, based on the weight of the pigment particles, wherein the first and second organic treating agents are different and the second organic treating agent includes at least one medium-chain triglyceride.

In yet another embodiment, a treated, titanium dioxide pigment for use in a polymer composition is provided. In this embodiment, the pigment comprises a plurality of titanium dioxide pigment particles, each of the particles having a surface; an inorganic treating agent deposited on the surfaces of the pigment particles, a first organic treating agent deposited on the surfaces of the pigment particles on top of the inorganic treating agent, and a second organic treating agent deposited on the surfaces of the pigment particles on top of the inorganic treating agent in an amount in the range of from about 0.2% to about 2% by weight, based on the weight of the pigment particles, wherein the second organic treating agent includes at least one medium-chain triglyceride.

In yet another embodiment, a polymer composition is provided. In this embodiment, the polymer composition comprises at least one polymer; and a treated, titanium dioxide pigment. The treated, titanium dioxide pigment includes: a plurality of titanium dioxide particles, each of the particles having a surface; and in the range of from about 0.2% to about 2% by weight, based on the weight of the titanium dioxide particles, of an organic treating agent deposited on the surfaces of the titanium dioxide particles, wherein the organic treating agent includes at least one medium-chain triglyceride. The treated, titanium dioxide pigment is present in the polymer composition in an amount in the range of from about 30% to about 80% by weight, based on the total weight of the polymer composition. The polymer is selected from the group consisting of polyolefins, acrylic resins, polyester resins, polyamide resins, styrenic resins, polyvinyl chloride, polycarbonate resins, and mixtures thereof.

### Illustrative Examples

The process for producing a treated, titanium dioxide pigment for use in a polymer composition, the treated titanium dioxide pigment for use in a polymer composition, and the polymer composition disclosed herein are exemplified by the following examples. The examples are given by way of example only and should not be taken as limiting of the process, treated pigment and polymer composition disclosed herein in any way. The examples illustrate specific embodiments consistent with the present disclosure but do not limit the scope of the disclosure or the appended claims.

The treated, titanium dioxide pigment disclosed herein and its performances in plastics were tested by evaluating the following properties of the pigment: pigment odor, pigment dry block brightness and color, pigment bulk density, pigment equilibrium torque, pigment melt flow index, pigment screen pack dispersion, and pigment lacing. Each test is generally described below.

Pigment odor: The smell of the finished pigment was qualitatively rated as no odor, mild odor, and strong odor. Less odor is preferred.

Pigment dry block brightness and color: The finished pigment was formed into pellets using a formed stainless-steel die, and then evaluated using a Hunter lab model Ultrascan XE spectrophotometer operating for 30 seconds at 3000 psi. The spectrophotometer allowed the brightness (L*) and color (b*) of the pelletized pigment to be measured. A higher L* value indicated that the pigment is brighter and therefore more preferred. A higher b* value indicated that the pigment is more yellow in color and therefore less preferred.

Pigment bulk density: The pigment was gently put in a bulk density measuring cup. Once the cup was overflowing, extra pigment from the top of the cup was scraped off. The measured density was then reported as pour bulk density. When testing tap density, the density cup was placed in an automatic tapping device such as Hosokawa Powder Tester, and a plastic cup extension was placed on top of the density cup. The cup was filled with the pigment and the pigment was tapped for 180 seconds. More pigment was added if the level of pigment was packed below the edge of the cup during the tapping step. When the cycle was complete, the extension was removed, and the extra pigment was scraped off from the top of the cup. The measured density after tapping was then reported as tap density. A higher bulk density is preferred for plastic grade titanium dioxide pigments since it can improve the plastic processing production rate.

Pigment equilibrium torque: An amount of 109.5 grams of the pigment to be tested was mixed with 36.5 grams of linear low-density polyethylene (LLDPE) (DOW 9820) to prepare a 75% by weight titanium dioxide-containing LLDPE concentrate. The components were thoroughly mixed together by masticating the components in the mixing bowl of an ATR Plasti-corder (C. W. Brabender Instruments, Inc.) operating at 100° C. and at a mixing speed of 100 rpm.

Instantaneous torque and temperature values were then recorded over a nine-minute period to ensure equilibrium mixing conditions were attained. Equilibrium torque values were determined via averaging the minimum measured instantaneous torque value over a one-minute period before and a one-minute period after the minimum mixing condition had been achieved.

Pigment melt flow: The 75% by weight titanium dioxide-containing LLDPE concentrate polymer concentrate from the equilibrium torque test was cooled down and ground into pellets, and the melt flow index value was determined on the resulting pellet concentrate using ASTM method D1238, procedure B, and reported as grams per 10 minutes.

Pigment screen pack dispersion: An amount of 100 g of the 75% by weight titanium dioxide-containing LLDPE concentrate described above was then extruded through a 500-mesh screen filter using a 0.75-inch barrel and 25:1 length to diameter extruder attached to the aforementioned Plasti-corder. The Plasti-corder was operated at an average processing temperature of approximately 190° C. and at 75 rpm. The maximum extruder processing pressure was recorded as screen pack maximum pressure. The amount of inorganic residue left on the 500-mesh screen filter, reported as pigment grit content in parts-per-million based on the amount of the pigment, was determined gravimetrically via heating the post-extrusion screen in a muffle furnace at 700° C. for ten minutes, cooling the screen to room temperature, and then subsequently weighing the screen, with comparison to its weight prior to use.

Generally, a lower equilibrium torque, higher melt flow index, and better screen pack dispersion (lower screen pack residue and low maximum pressure) are preferred in plastic grade titanium dioxide pigments.

Pigment lacing: A base resin was prepared by combining ground low density polyethylene (LDPE) having a melt flow index of 12 (Dow 4012) with 0.05% by weight Irganox 900 (a thermal stabilizer) and rolling the mixture for two hours to blend the components together. A 50% mixture of the prepared base resin and titanium dioxide pigment was then rolled for two hours to blend the components together. The blend was then extruded through a twin-screw extruder fitted with a rod die. The extruded strand was then fed through a water bath and pelletized. The 50% titanium dioxide loaded pellets were then dried overnight at 100° C. After the concentrate had dried overnight, it was blended with a low density polyethylene resin having a melt flow index of 8 (Dow 722) at various levels, and then fed through a ¾″ single screw extruder fitted with a 4″ ribbon die at a 25 μm film thickness. The test was repeated at varying ratios of polyethylene concentrate and the low density polyethylene resin having a melt flow index of 8 (Dow 722) until the concentration of titanium dioxide was high enough to cause lensing or lacing. The highest percentage of titanium dioxide concentration which did not causing lacing was reported. A higher lacing reading is preferred in plastic-grade titanium dioxide pigments.

### Treatment Example 1

### Titanium Dioxide Filter Cake (Chloride Process)—No Inorganic Treatment

Titanium dioxide pigment particles formed by the chloride process were dispersed in water to form a raw slurry having a pH of 3 to 4. The resulting slurry was then subjected to sand milling (using a zircon sand-to-pigment weight ratio of 4:1) until 90% of the particles were smaller than 0.63 microns (as determined by a Microtrac X 100 Particle Size Analyzer) to achieve an aqueous dispersion with a solids content of 35%.

The slurry, now diluted to a 30% solids content, was then heated to 85° C., and the pH of the slurry was adjusted to 7.0 with a sodium hydroxide solution. The slurry was then allowed to digest for 10 minutes, and then filtered while hot. The resulting filtrate was washed with water, which had been preheated to 60° C. A wet titanium dioxide filter cake without inorganic treatment was obtained.

### Comparative Example 1

Pigment Prepared with BIS and TMP

The wet titanium dioxide filter cake from Treatment Example 1 was mixed with deionized water in an amount equal to 1000 g of dry pigment to form a paste. Next, 3.1 grams of bis(2,4,4-trimethylpentyl) phosphinic acid (BIS) was added to and mixed well with the paste. The treated, titanium dioxide paste was then dried in an oven at 115° C. to a moisture content of less than 1%.

Next, 4.85 g of a 33% trimethylolpropane (TMP) aqueous solution was added to the dried filter cake. The dried pigment was crushed to yield a dry pigment powder. The dry pigment powder was then steam micronized utilizing a steam-to-pigment weight ratio of 2.5:1 with the steam injector pressure set at 160 psi and the micronizer ring pressure set at 118 psi.

### Disclosed Organic Treating Agent Example 1

Pigment Treated with Medium-Chain Triglyceride

The wet titanium dioxide filter cake from Treatment Example 1 was mixed in an amount equal to 1000 grams of dry pigment with deionized water to form a paste. Next, 8.0 grams of a single medium-chain triglyceride fractionated from coconut oil was added to the paste and mixed well therewith. The aliphatic tails of the fatty acids of the medium-chain triglyceride had from 7 to 9 carbon atoms.

The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 2.5:1 with the steam injector pressure set at 160 psi and the micronizer ring pressure set at 118 psi.

Next, the treated pigments from Comparative Example 1 (BIS/TMP) and Disclosed Organic Treating Agent Example 1 (MCT Oil) were tested for dry block brightness, dry block color, pour bulk density, tap bulk density, pigment odor, equilibrium torque, melt flow index, screen pack residue, screen pack maximum pressure, and lacing in accordance with the corresponding test procedures described above. The results are listed in Table 1 below:

TABLE 1

| | | Disclosed Organic |
|---|---|---|
| | Comparative | Treating Agent |
| | Example 1 | Example 1 |
| Surface Organic | BIS/TMP | MCT Oil |
| Dry block brightness (L*) | 98.7 | 98.6 |
| Dry block color (b*) | 1.1 | 1.1 |
| Pour bulk density | 0.63 | 0.91 |
| Tap bulk density | 1.22 | 1.41 |
| Pigment odor | No odor | No odor |
| Equilibrium Torque, m-g | 1071 | 969 |
| Melt flow index, g/10 min | 17 | 27 |
| Screen pack residue, ppm | 83 | 76 |
| Screen pack maximum pressure, psi | 553 | 518 |
| Lacing at 300 C., % loading | 26 | 28 |

As shown above, the pigment treated with a medium-chain triglyceride as disclosed herein had the same or a better performance than the control pigment (treated with bis(2,4,4-trimethylpentyl) phosphinic acid (BIS) and trimethylolpropane (TMP)).

### Treatment Example 2

Titanium Dioxide Filter Cake (Sulfate Process)—with Inorganic Treatment

Titanium dioxide pigment particles having a rutile crystalline structure and formed by the sulfate process were dispersed in water in the presence of 0.1% of sodium hexametaphosphate dispersant, along with sufficient amount of sodium hydroxide to adjust the pH of the dispersion to 9.5 or higher to achieve an aqueous dispersion with a solid content of 35%. The resulting slurry was subjected to sand milling (using a zircon sand-to-pigment weight ratio of 4:1) until 90% of the particles were smaller than 0.63 microns, as determined by Microtrac X 100 Particle Size Analyzer. The resulting slurry had a 30% solids content.

Next, 1.0% of sodium aluminate (calculated as alumina by weight of final pigment) was added to the slurry over a 20-minute period of time. After allowing the slurry to digest for 10 minutes, the pH of the slurry was adjusted to 7.0 with concentrated sulfuric acid. The slurry was then filtered, and the resulting filtrate was washed with water. A wet titanium dioxide filter cake with alumina coated onto the pigment particles was obtained.

### Comparative Example 2

Pigment Prepared with Phosphorinated Fatty Oil (PFA)

The wet titanium dioxide filter cake from Treatment Example 2 in an amount equal to 1000 grams of dry pigment was mixed with deionized water to form a paste. Next, 8.0 grams of phosphorinated fatty acid (PFA) was added to and mixed well with the paste. The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 2.5:1, with the steam injector pressure set at 160 psi and the micronizer ring pressure set at 118 psi.

### Disclosed Organic Treating Agent Example 2

Pigment Treated with Medium-Chain Triglyceride

The wet titanium dioxide filter cake from Treatment Example 2 in an amount equal to 1000 grams of dry pigment was mixed with deionized water to form a paste. Next, 8.0 grams of a single medium-chain triglyceride fractionated from coconut oil was added to the paste and mixed well therewith. The aliphatic tails of the fatty acids of the medium-chain triglyceride had from 7 to 9 carbon atoms.

The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 2.5:1, with the steam injector pressure set at 160 psi and the micronizer ring pressure set at 118 psi.

Next, the treated pigments from Comparative Example 2 (PFA) and Disclosed Organic Treating Agent Example 2 (MCT Oil) were tested for dry block brightness, dry block color, pour bulk density, tap bulk density, pigment odor, equilibrium torque, melt flow index, screen pack residue, screen pack maximum pressure, and lacing in accordance with the corresponding test procedures described above. The results are listed in Table 2 below:

TABLE 2

| | | Disclosed Organic |
|---|---|---|
| | Comparative | Treating Agent |
| | Example 2 | Example 2 |
| Surface organic | PFA | MCT oil |
| Dry block brightness (L*) | 97.6 | 98.0 |
| Dry block color (b*) | 2.5 | 1.6 |
| Pour bulk density | 0.49 | 0.51 |
| Tap bulk density | 0.90 | 0.94 |
| Pigment odor | Mild odor | No odor |
| Equilibrium Torque, m-g | 1210 | 1221 |
| Melt flow index, g/10 min | 14 | 16 |
| Screen pack residue, ppm | 120 | 80 |
| Screen pack maximum pressure, psi | 556 | 535 |
| Lacing at 300 C., % loading | 18 | 22 |

As shown above, the pigment treated with a medium-chain triglyceride as disclosed herein had the same or a better performance than the control pigment (treated with phosphorinated fatty acid (PFA)).

### Treatment Example 3

Titanium Dioxide Filter Cake (Chloride)—with Inorganic Treatment

Titanium dioxide pigment particles having a rutile crystalline structure and formed by the chloride process was dispersed in water in the presence of 0.1% of sodium hexametaphosphate dispersant, along with sufficient amount of sodium hydroxide to adjust the pH of the dispersion to 9.5 or higher to achieve an aqueous dispersion with a solid content of 35%. The resulted slurry was subjected to sanding milling (using a zircon sand-to-pigment weight ratio of 4:1) until 90% of the particle size were smaller than 0.63 microns, as determined by Microtrac X 100 Particle Size Analyzer.

The slurry, now diluted to a 30% solid content, was heated to 60C, and the pH of the slurry was adjusted to 2.0 with concentrated sulfuric acid. Next, 1.0% sodium aluminate (calculated as alumina by weight of final pigment) was added to the slurry. After allowing the slurry to digest for 15 minutes, the pH of the slurry was adjusted to 6.0 with concentrated sulfuric acid.

The slurry was then filtered while hot. The resulting filtrate was washed with water, which had been preheated to 60C. A wet titanium dioxide filter cake with alumina coated on the pigment particles was obtained.

### Comparative Example 3A

Pigment Prepared with Trimethylolpropane (TMP)

The wet titanium dioxide filter cake from Treatment Example 3 in an amount equal to 1000 grams of dry pigment was mixed with deionized water to form a slurry having a solids content of 50%. Next, 10.61 grams of a 33% trimethylolpropane (TMP) aqueous solution were added to and mixed well with the slurry. The treated titanium dioxide slurry was then dried in an oven at 115° C. to a moisture content of less than 1%. The dried pigment was crushed to yield a dry pigment powder. The dry pigment powder was then steam micronized utilizing a steam-to-pigment weight ratio of 1.8:1, with the steam injector pressure set at 160 psi and the micronizer ring pressure set at 118 psi. The particle size of the finished pigment was determined by a Microtrac X 100 Particle Size Analyzer and reported as % Pass at 0.63 microns.

### Comparative Example 3B

Pigment Prepared with Corn Oil

The wet titanium dioxide filter cake from Treatment Example 3 in an amount equal to 1000 grams of dry pigment was mixed with deionized water to form a paste. Next, 8.0 grams of corn oil were added to and mixed well with the paste. The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 1.8:1, with the steam injector pressure set at 160 psi and the micronizer ring pressure set at 118 psi.

### Comparative Example 3C

Pigment Prepared with Soybean Oil

The wet titanium dioxide filter cake from Treatment Example 3 in an amount equal to 1000 grams of dry pigment was mixed with deionized water to form a paste. Next, 8.0 grams of soybean oil were added to and mixed well with the paste. The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 1.8:1, with the steam injector pressure set at 160 psi and the micronizer ring pressure set at 118 psi.

### Comparative Example 3D

Pigment Prepared with Canola Oil

The wet titanium dioxide filter cake from Treatment Example 3 in an amount equal to 1000 grams of dry pigment was mixed with deionized water to form a paste. Next, 8.0 grams of canola oil were added to and mixed well with the paste. The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 1.8:1, with the steam injector pressure set at 160 psi and the micronizer ring pressure set at 118 psi.

### Disclosed Organic Treating Agent Example 3

Pigment Treated with Medium-Chain Triglyceride

The wet titanium dioxide filter cake from Treatment Example 3 in an amount equal to 1000 grams of dry pigment was mixed with deionized water to form a paste. The pH of the paste was checked and determined to be 7.4. Next, 8.0 grams of a single medium-chain triglyceride fractionated from coconut oil was added to the paste and mixed well therewith. The aliphatic tails of the fatty acids of the medium-chain triglyceride had from 7 to 9 carbon atoms.

The treated titanium dioxide paste was then dried in an oven at 115° C. to a moisture content of less than 1%. The dried pigment was crushed to yield a dry pigment powder. The dry pigment powder was then steam micronized utilizing a steam-to-pigment weight ratio of 2.5:1, with the steam injector pressure set at 160 psi and the micronizer ring pressure set at 118 psi.

Next, the treated pigments from Comparative Example 3A (TMP), Comparative Example 3B (corn oil), Comparative Example 3C (soybean oil), Comparative Example 3D (canola oil) and Disclosed Organic Treating Agent Example 3 (MCT Oil) were tested for dry block brightness, dry block color, and pigment odor in accordance with the corresponding test procedures described above. The results are listed in Table 3 below:

TABLE 3

| | Disclosed | | | | |
|---|---|---|---|---|---|
| | Organic | | | | |
| | Treating Agent | Comparative | Comparative | Comparative | Comparative |
| | Example 3 | Example 3A | Example 3B | Example 3C | Example 3D |
| Surface organic | MCT Oil | TMP | Corn Oil | Soybean oil | Canola Oil |
| Dry block brightness (L*) | 98.2 | 98.3 | 97.8 | 97.7 | 98.0 |
| Dy block color (b*) | 1.0 | 1.0 | 2.2 | 2.4 | 1.7 |
| Pigment odor | No odor | No odor | Strong odor | Strong odor | Strong odor |

As shown above, the pigment treated with a medium-chain triglyceride as disclosed herein had a comparable performance in brightness (L*) and color (b*) to the control pigment treated with TMP. The pigment treated with a medium-chain triglyceride as disclosed herein had a better performance in terms of brightness (L*), a less yellow color (lower b*) and lower odor (no odor) compared to the various vegetable oils tested. The yellow color and strong odor associated with the vegetable oil treatments are unacceptable for plastic grade titanium dioxide pigments.

### Comparative Example 4

TiO₂ Pigment Treated with MCT Oil at Filter Cake pH<6.0

The wet titanium dioxide filter cake from Treatment Example 3 in an amount equal to 1000 grams of dry pigment was mixed with deionized water to form a paste. The pH of the paste was checked and determined to be 7.4. Sulfuric acid was then added into the paste while mixing the sulfuric acid and paste together to adjust the pH of the paste to 5.2. Next, 8.0 grams of a medium-chain triglyceride were added to and mixed well with the acidic paste. The aliphatic tails of the fatty acids of the medium-chain triglyceride had from 7 to 9 carbon atoms.

The organic treated titanium dioxide paste was then dried in an oven at 115° C. to a moisture content of less than 1%. The dried pigment was then crushed to yield a dry pigment powder. The dry pigment powder was then steam micronized utilizing a steam-to-pigment weight ratio of 1.8:1, with the steam injector pressure set at 160 psi and the micronizer ring pressure set at 118 psi.

Next, each of the finished titanium dioxide pigments of Disclosed Organic Treating Agent Example 3 and Comparative Example 4 (each treated with a medium-chain triglyceride) were separately tested for thermal odor stability. Each test was carried out by placing the pigment an oven operating at 200° C., and checking the odor associated with the pigment after 1, 3 and 5 hours of thermal aging in the oven.

It was found that the odor of the finished titanium dioxide pigment of Disclosed Organic Treating Agent Example 3 was very mild. A moderate old cooking oil odor could only be detected when being close to the sample container. On the other hand, the finished pigment of Comparative Example 4 had a strong, pungent, burning oil odor. The odor could be detected throughout the test lab even before the oven door was opened. Thus, assuring that the pH of the filter cake to which the organic treating agent is added or mixed is greater than 6 helps prevent degradation of the medium-chain triglyceride(s) forming the organic treating agent and the resulting odor associated therewith.

Thus, the process, treated pigment, and polymer composition are well adapted to attain the ends and advantages mentioned, as well as those that are inherent therein. The particular examples disclosed above are illustrative only, as the present process, treated pigment, and polymer composition may be modified and practiced in different but equivalent manners apparent to those skilled in the art having the benefit of the teachings herein. While the process, treated pigment, and polymer composition are described in terms of “comprising,” “containing,” “having,” or “including” various components or steps, the process, treated pigment, and polymer composition can also, in some embodiments, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A process for producing a treated, titanium dioxide pigment for use in a polymer composition, comprising:
providing a plurality of titanium dioxide pigment particles, each of said particles having a surface; and
depositing an organic treating agent on said surfaces of said pigment particles in an amount in the range of from about 0.2% to about 2% by weight, based on the weight of said pigment particles, wherein said organic treating agent includes at least one medium-chain triglyceride.

2. The process of claim 1, wherein said organic treating agent is deposited on the surfaces of said pigment particles in an amount in the range of from about 0.3% to about 1.6% by weight, based on the weight of said pigment particles.

3. The process of claim 1, wherein each of the aliphatic tails of the saturated fatty acids of said medium-chain triglyceride has in the range of from 7 to 9 carbon atoms.

4. The process of claim 1, wherein said organic treating agent includes two or more medium-chain triglycerides, with each medium chain triglyceride having a different structure.

5. The process of claim 1, further comprising:
prior to depositing said organic treating agent on said surfaces of said pigment particles:
forming a slurry of said pigment particles; and
filtering said slurry to form a filter cake that includes said pigment particles, wherein said organic treating agent is deposited on said surfaces of said pigment particles by mixing said organic treating agent with said filter cake.

6. The process of claim 1, further comprising depositing an inorganic treating agent on said surfaces of said pigment particles.

7. The process of claim 6, wherein said inorganic treating agent is selected from the group of metal oxide materials, metal hydroxide materials, and combinations thereof.

8. The process of claim 1, wherein said organic treating agent is a second organic treating agent, and said process further comprises:
depositing a first organic treating agent on said surfaces of said pigment particles.

9. The process of claim 8, wherein said first organic treating agent is selected from the group consisting of phosphinic acids, derivatives of phosphinic acids, phosphonic acids, derivatives of phosphonic acids, fatty acids, derivatives of fatty acids, siloxanes, amines, hydroxyl amines, polyols, silanes, and combinations thereof.

10. The process of claim 8, wherein said first treating agent is deposited on said surfaces of said pigment particles in an amount in the range of from about 0.05% to about 1.0% by weight, based on the weight of said pigment particles.

11. A process for producing a treated, titanium dioxide pigment for use in a polymer composition, comprising:
(a) providing a plurality of titanium dioxide pigment particles;
(b) after step (a), forming an aqueous slurry of said titanium dioxide pigment particles;
(c) after step (b), reducing the particle size of said titanium dioxide particles in the aqueous slurry to a desired particle size;
(d) after step (c), depositing at least one inorganic treating agent onto the surfaces of the titanium dioxide pigment particles in said aqueous slurry;
(e) after step (d), filtering said treated titanium dioxide pigment particles to form a filter cake that includes the treated, titanium dioxide pigment particles;
(f) after step (e), mixing an organic treating agent with said filter cake to deposit said organic treating agent on said titanium dioxide particles, wherein said organic treating agent includes at least one medium-chain triglyceride;
(g) after step (e), drying said filter cake; and
(h) after step (g), reducing the particle size of said treated, titanium dioxide particles forming the filter cake to a desired particle size.

12. The process of claim 14, wherein said organic treating agent is a second organic treating agent, and said process further comprises:
depositing a first organic treating agent on said surfaces of said pigment particles.

13. A treated, titanium dioxide pigment for use in a polymer composition, comprising:
a plurality of titanium dioxide pigment particles, each of said particles having a surface;
an inorganic treating agent deposited on said surfaces of said pigment particles; and
an organic treating agent deposited on said surfaces of said pigment particles on top of said inorganic treating agent in an amount in the range of from about 0.2% to about 2% by weight, based on the weight of said pigment particles, wherein said organic treating agent includes at least one medium-chain triglyceride.

14. The treated, titanium dioxide pigment of claim 13, wherein each of the aliphatic tails of the saturated fatty acids of said medium-chain triglyceride has in the range of from 7 to 9 carbon atoms.

15. The treated, titanium dioxide pigment of claim 13, wherein said organic treating agent is deposited on the surfaces of said pigment particles in an amount in the range of from about 0.3% to about 1.6% by weight, based on the weight of said pigment particles.

16. The treated, titanium dioxide pigment of claim 13, wherein said inorganic treating agent is selected from the group of metal oxide materials, metal hydroxide materials, and combinations thereof.

17. The treated, titanium dioxide pigment of claim 13, wherein said organic treating agent is a second organic treating agent, and said treated, titanium dioxide pigment further comprises a first organic treating agent deposited on said surfaces of the pigment particles.

18. The treated, titanium dioxide pigment of claim 17, wherein said first organic treating agent is selected from the group consisting of alkyl phosphinic acids, derivatives of alkyl phosphinic acids, phosphonic acids, derivatives of phosphonic acids, siloxanes, silanes, and combinations thereof.

19. The treated, titanium dioxide pigment of claim 17, wherein said first treating agent is deposited on said surfaces of said pigment particles in an amount in the range of from about 0.05% to about 1.0% by weight, based on the weight of said pigment particles.

20. A polymer composition, comprising:
at least one polymer; and
a treated, titanium dioxide pigment, said pigment including:
a plurality of titanium dioxide particles, each of said particles having a surface; and
in the range of from about 0.2% to about 2% by weight, based on the weight of said titanium dioxide particles, of an organic treating agent deposited on the surfaces of said titanium dioxide particles, wherein said organic treating agent includes at least one medium-chain triglyceride.

21. The polymer composition of claim 20, wherein said treated, titanium dioxide pigment further comprises an inorganic treating agent deposited on said surfaces of said pigment particles, wherein said organic treating agent is deposited on said surfaces of said pigment particles on top of said inorganic treating agent.

22. The polymer composition of claim 20, wherein said organic treating agent deposited on the surfaces of said titanium dioxide particles of said treated, titanium dioxide particles is a second organic treating agent, and said treated, titanium dioxide pigment further comprises a first organic treating agent deposited on said surfaces of the pigment particles.

23. The polymer composition of claim 22, wherein said first organic treating agent is selected from the group consisting of alkyl phosphinic acids, derivatives of alkyl phosphinic acids, phosphonic acids, derivatives of phosphonic acids, siloxanes, silanes, and combinations thereof.

24. The polymer composition of claim 20, wherein said polymer(s) is selected from the group consisting of polyolefins, acrylic resins, polyester resins, polyamide resins, styrenic resins, polyvinyl chloride, polycarbonate resins, and mixtures thereof.

25. The polymer composition of claim 20, wherein said treated, titanium dioxide pigment is present in said polymer composition in an amount in the range of from about 30% to about 80% by weight, based on the total weight of the polymer composition.
